(19) United States
(12) Patent Application Publication
(10) Pub. No.: US 2026/0329535 A1
(43) Pub. Date: Oct. 22, 2026

(54) CIRCUIT OF ADDER TREE AND METHOD OF OPERATING THE SAME

(71) Applicants: TAIWAN SEMICONDUCTOR MANUFACTURING COMPANY, LTD., Hsinchu (TW); NATIONAL TAIWAN UNIVERSITY, TAIPEI (TW)

(72) Inventors: He-Wen SHEN, Taipei City (TW); Je-Min HUNG, Hsinchu City (TW); Hidehiro FUJIWARA, Hsinchu City (TW); Chee-Wee LIU, Taipei City (TW); Hung-Jen LIAO, Hsinchu City (TW)

(73) Assignees: TAIWAN SEMICONDUCTOR MANUFACTURING COMPANY, LTD., Hsinchu (TW); NATIONAL TAIWAN UNIVERSITY, TAIPEI (TW)

(21) Appl. No.: 19/183,630

(22) Filed: Apr. 18, 2025

(51) Int. Cl. G06F 7/505; G06F 7/74

(52) U.S. Cl. CPC G06F 7/505; G06F 7/74

(57) ABSTRACT

A circuit is provided. The circuit includes a first adder circuit to output N bits. The first adder circuit includes a first bit adder to an M-th bit adder. A first portion of the first bit adder to the M-th bit adder includes first adders each having a first number of transistors. The first adder circuit further includes an (M+1)-th bit adder to an N-th bit adder including second adders each having a second number of transistors. First accuracy of one in the first adders is lower than second accuracy of one in the second adders, M and N being natural numbers.

### BACKGROUND

Digital compute-in-memory (CIM) suffers from high energy consumption when processing large datasets. A significant portion of the total power in a computing macro is consumed by the adder tree.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a full adder, in accordance with various embodiments of the present disclosure.

FIG. 2 is a schematic diagram illustrating an approximate adder, in accordance with various embodiments of the present disclosure.

FIG. 3 is a schematic diagram illustrating an adder circuit, in accordance with various embodiments of the present disclosure.

FIG. 4 is a schematic diagram illustrating an adder circuit corresponding to FIG. 3, in accordance with various embodiments of the present disclosure.

FIG. 5 is a schematic diagram showing an example of an adder tree, in accordance with various embodiments of the present disclosure.

FIG. 6 is a schematic diagram illustrating an approximate adder, in accordance with various embodiments of the present disclosure.

FIG. 7 is a schematic diagram illustrating an adder circuit, in accordance with various embodiments of the present disclosure.

FIG. 8 is a schematic diagram illustrating an adder circuit corresponding to FIG. 7, in accordance with various embodiments of the present disclosure.

FIG. 9 is a schematic diagram showing an example of an adder tree, in accordance with various embodiments of the present disclosure.

FIG. 10 is a schematic diagram showing part of the adder tree corresponding to FIG. 9, in accordance with various embodiments of the present disclosure.

FIG. 11 is a schematic diagram illustrating an adder circuit, in accordance with various embodiments of the present disclosure.

FIG. 12 is a schematic diagram illustrating an adder circuit corresponding to FIG. 11, in accordance with various embodiments of the present disclosure.

FIG. 13 is a schematic diagram illustrating an adder circuit corresponding to FIG. 11, in accordance with various embodiments of the present disclosure.

FIG. 14A is a schematic diagram showing an example of an adder tree, in accordance with various embodiments of the present disclosure.

FIG. 14B is a schematic diagram showing an example of an adder tree, in accordance with various embodiments of the present disclosure.

FIG. 15 is a schematic diagram illustrating an approximate adder, in accordance with various embodiments of the present disclosure.

FIG. 16 is a schematic diagram illustrating an approximate adder, in accordance with various embodiments of the present disclosure.

FIG. 17 is a schematic diagram illustrating an adder circuit, in accordance with various embodiments of the present disclosure.

FIG. 18 is a flowchart diagram of an operational method of adder circuits, in accordance with some embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

In some embodiments, a new adder tree structure employing a new architecture of approximate adders is introduced, designed to enhance the energy and area efficiency of high-performance computing within digital compute-in-memory (DCIM) applications. Current DCIM systems face significant challenges in processing large datasets due to the substantial energy consumption of the adder tree, a critical component within the overall system architecture. Full adders, commonly used in these systems, contribute significantly to this high power consumption. In contrast, this invention leverages the inherent advantages of approximate adders, specifically a novel interleaved design, to create an adder tree that drastically reduces power demands while maintaining acceptable accuracy for many compute-in-memory tasks. The resulting architecture is anticipated to be highly scalable and suitable for massive deployment in future generations of DCIM systems, leading to substantial improvements in overall system performance and energy efficiency.

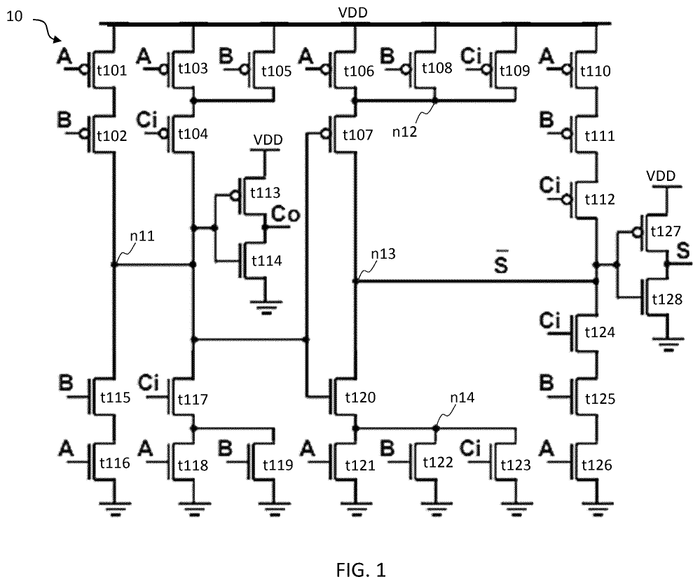

Reference is now made to FIG. 1. FIG. 1 is a schematic diagram illustrating a full adder 10, in accordance with various embodiments of the present disclosure. For illustration, the full adder 10 includes 28 transistors t101 to t128, in which the transistors t101-t113 and t127 are P type transistors and the transistors t114-t126 and t128 are N type transistors. In some embodiments, the full adder 10 is configured to perform addition on three inputs—two 1-bit data, for example, inputs A and B and a carry input Ci—to generate two output: a carry output Co, a sum output S.

As shown in FIG. 1, the transistors t101, t103, t106, t10 receive the input A at control terminals thereof and are further coupled to the supply voltage VDD. The transistors t116, t118, t121, t126 receive the input A at control terminals thereof and are further coupled to the ground. The transistors t105, t108, t111 receive the input B at control terminals thereof and are further coupled to the supply voltage VDD. The transistors t119, t122 receive the input B at control terminals thereof and are further coupled to the ground. The transistors t102, t111, t115, and t125 receive the input B at control terminals thereof. The transistors t109 and t123 receive the carry input Ci at control terminals thereof and are further coupled to the supply voltage VDD and the ground respectively. The transistors t104, t112, t117, t124 receive the carry input Ci at control terminals thereof.

Specifically, the transistors t101-t105 and t115-t116 are coupled in series between the supply voltage VDD and the ground, and the transistors t103-t104 and t117-t118 are coupled in series between the supply voltage VDD and the ground. An input of an inverter composed of the transistors t113-114 is coupled to the transistors t102, t104, t115, t117 at the node n11, and the output of the inverter generates the carry output Co. The transistor t105 is coupled between the transistor t104 and the supply voltage VDD. The transistor t109 is coupled between the transistor t117 and the ground. The transistors t106-t107, t120-121 are coupled between the supply voltage VDD and the ground, in which the transistors t107 and t120 form an inverter having an input coupled to the node n11 and an output coupled to a node n13 between the transistors t112 and t124. The transistors t108-109 are coupled between the supply voltage VDD and a node n12 between the transistors t106-t107. The transistors t122-123 are coupled between the ground and a node n14 between the transistors t120-t121. The transistors t110-t112 and t124-t126 are coupled in series between the supply voltage VDD and the ground. The voltage level at the node n13 corresponds to a complementary state of the sum output S. The input of an inverter formed by the transistors t127-t128 is coupled to the node n13 and the output thereof generates the sum output S.

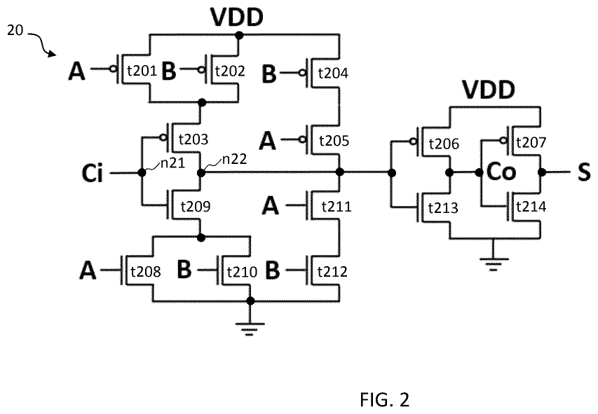

Reference is now made to FIG. 2. FIG. 2 is a schematic diagram illustrating an approximate adder 20, in accordance with various embodiments of the present disclosure. The approximate adder 20 includes 14 transistors t201 to t214. The transistors t201, 205, t208, t211 receive the input A at the control terminal thereof. The transistors t202, 204, t210, t212 receive the input B at the control terminal thereof.

As shown in FIG. 2, the transistors t201-t202 of P type are coupled in parallel between the supply voltage VDD and an inverter that is composed of a transistor t203 of P type and a transistor t209 of N type and has an input receiving the carry input Ci and an output coupled to a node n22. The transistors t208-t210 of N type are coupled in parallel between the transistor t209 and the ground. The transistors t204-t205 and t211-t212 are coupled between the supply voltage VDD and the ground and the node n22 is interposed between the transistors t205 and t11. Two inverters formed by the transistors t206, t213 and t207, t214 respectively are coupled in series between the node n22 and the sum output S. The control terminals of the transistors t206, t213 are coupled to the node n22, and the control terminals of the transistors t207, t214 correspond to the carry output Co.

In some embodiments, the approximate adder 20 truth table is shown as Table I below. In some embodiments, as shown in table I, an error occurs in the sum output S when the inputs A, B, and the carry input Ci are all “0” or all “1”. Accordingly, accuracy of the approximate adder 20 is worse than accuracy of the full adder 10 as the full adder 10 has no error in calculation.

TABLE I
truth table of the approximate adder 20

| | |
|---|---|
| INPUT | OUTPUT |

| A | B | Ci | S | Co |
|---|---|---|---|---|
| 0 | 0 | 0 | 1 (X) | 0 |
| 0 | 0 | 1 | 1 | 0 |
| 0 | 1 | 0 | 1 | 0 |
| 0 | 1 | 1 | 0 | 1 |
| 1 | 0 | 0 | 1 | 0 |
| 1 | 0 | 1 | 0 | 1 |
| 1 | 1 | 0 | 0 | 1 |
| 1 | 1 | 1 | 0 (X) | 1 |

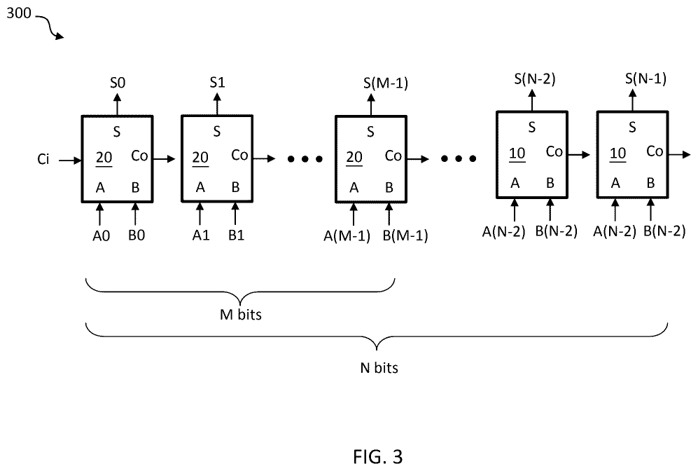

Reference is now made to FIG. 3. FIG. 3 is a schematic diagram illustrating an adder circuit 300, in accordance with various embodiments of the present disclosure. In some embodiments, the adder circuit 300 is configured to add two (N−1)-bit inputs (e.g., an input A including (N−1) bits A0 to A(N−2) and an input B including (N−1) bits B0 to B(N−2)) plus a carry input (e.g., Ci) to produce an N-bit sum output S (including N bits S0 to S(N−1)) and a carry output Co (e.g., an output of the last adder in the adder circuit 300), as shown in FIG. 3. In some embodiments, the adder circuit 300 is referred to as an N bit adder.

According to the embodiments of FIG. 3, the adder circuit 300 includes a number M of approximate adders 20 coupled in series with each other and a number (N-M) of full adders 10 coupled in series with each other. The last one in series of the approximate adder 20 is coupled to the first one in series of the full adders 10. Specifically, the approximate adders 20 are configured to perform addition on the first bits A0 and B0 of the inputs A and B to the M-th bits A(M−1) and B(M−1) of the inputs A and B. The full adders 10 are configured to perform addition on the (M+1)-th bits AM and BM of the inputs A and B to the (N−1)-th bits A(N−2) and B(N−2) of the inputs A and B. M and N are natural number and M is smaller than N.

In some embodiments, the first portion of adders in the adder circuit 300 are configured to perform addition operation on least significant bits (LSBs) of inputs, for example, the first bits to the M-th bits, and the second portion of adders in the adder circuits 300 are configured to perform addition operation on most significant bits (MSBs) of inputs, for example, the (M+1)-th bits to the (N−1)-th bits, as shown in FIG. 3.

Furthermore, sign extension of the last bit—the (N−1)-th bit—is performed for the final adder in the second portion of adders to ensure accurate addition result. For instance, as shown in FIG. 3, the MSB bits A(N−2) and B(N−2) of the (N−1)-bit inputs A and B are sign bits and are fed into both adders that produce the output bits S(N−2) to S(N−1).

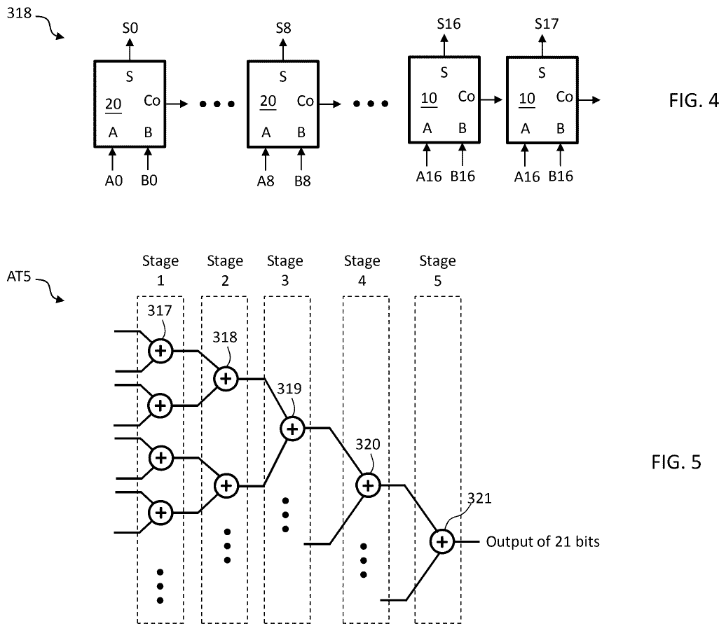

In some embodiments, a ratio of the approximate adders 20 in the adder circuit 300 over the full adders 10 is different from 1. The configurations of FIG. 3 are given for illustrative purposes. Various implements are within the contemplated scope of the present disclosure. For example, in some embodiments, a ratio of the approximate adders 20 in the adder circuit 300 over the full adders 10 equals to 1, as shown in FIG. 4.

Reference is now made to FIG. 4. FIG. 4 is a schematic diagram illustrating an adder circuit 318 corresponding to FIG. 3, in accordance with various embodiments of the present disclosure. The adder circuit 318 is configured as an 18-bit adder having nine approximate adders 20 and nine full adders 10 that are coupled in series to add the 17-bit inputs A and B to output 18-bit sum output S and a 1-bit carry output Co.

The configurations of FIG. 4 are given for illustrative purposes. Various implements are within the contemplated scope of the present disclosure.

Reference is now made to FIG. 5. FIG. 5 is a schematic diagram showing an example of an adder tree AT5, in accordance with various embodiments of the present disclosure. For illustration, the adder tree AT5 includes at least five stages. In some embodiments, each adder circuit in the adder tree AT5 have similar configurations corresponding to the adder circuit 300 in FIG. 3. For example, an adder circuit 317 is configured with respect to, for example, the adder circuit 300 configured as a 17-bit adder circuit (i.e., M being 8 and N being 17), an adder circuit 318 is configured with respect to, for example, the adder circuit 300 configured as a 18-bit adder circuit (i.e., M being 8 and N being 18), and so on.

As shown in FIG. 5, the adder tree AT5 includes multiple adder circuits 317 in the stage 1 for addition operation of inputs, for example, thirty two 17-bit inputs, and each adder circuit 317 generates a 17-bit sum output and an one-bit output Co to coupled one of the adder circuits 318 in the next stage 2. Each adder circuit 318 generates an 18-bit sum output and an one-bit output Co to coupled one of the adder circuits 319 in the next stage 3, and so on. Accordingly, the adder tree AT5 generates a 21-bit sum output as result of the sum of thirty two 16-bit inputs.

Compared with some approach utilizing more transistors for full adders, with the configurations of the present application, interleaved 14-T approximate adder 20 with the 28-T full adders 10 contribute significant power, performance, and area (PPA) improvement.

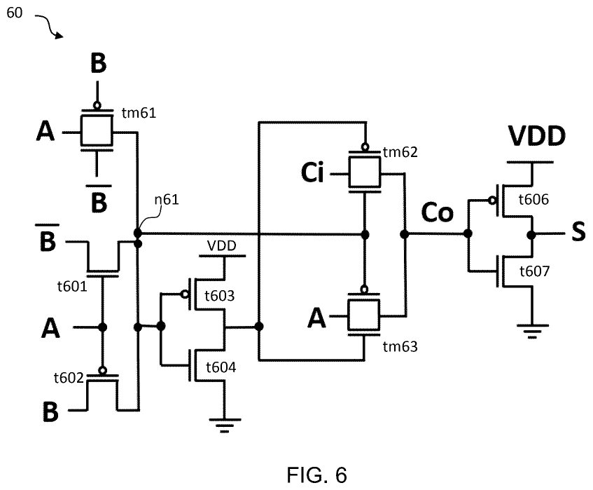

Reference is now made to FIG. 6. FIG. 6 is a schematic diagram illustrating an approximate adder 60, in accordance with various embodiments of the present disclosure.

As illustratively shown in FIG. 6, the approximate adder 60 includes transmission gates tm61-tm63 and transistors t601-t607. Specifically, the transmission gate tm61 is coupled between the input A and the node n61 and further couples to and operates in response to the input B and an input B that is inverted from the input B. The transmission gate tm6 has a P type transistor having a control terminal coupled to the input B and an N type transistor having a control terminal coupled to the input B, in which the P type transistor and the N type transistor mentioned above are coupled in parallel between the input A and the node n61.

The transistor t601 of N type is coupled between the input B and the node n61. The transistor t602 of P type is coupled between the input B and the node n61. Control terminals of the transistors t601 and t602 are coupled to the input A. An inverter formed by P transistor t603 and N type transistor t604 has an input terminal coupled to the node n61.

The transmission gate tm62 is coupled between the carry input Ci and the carry output (terminal) Co of the approximate adder 60 and further couples to and operates in response to an output of the inverter formed by the transistors t603-t604 and the node n61. The transmission gate tm63 is coupled between the input A and the carry output Co and further couples to and operates in response to the output inverter formed by the transistors t603-t604 and the node n61. Specifically, a control terminal of a P type transistor in the transmission gate tm62 and a control terminal of an N type transistor in the transmission gate tm63 are coupled to the output terminal of drains of the transistor t603 and t604. A control terminal of an N type transistor in the transmission gate tm62 and a control terminal of a P type transistor in the transmission gate tm63 are coupled to the node n61.

The P type transistor t606 and the N type transistor t607 form an inverter that is coupled between the carry output Co and the sum output terminal S of the approximate adder 60.

In some embodiments, a truth table of the approximate adder 60 is the same as that of the approximate adder 20, shown in Table I. Alternatively stated, the accuracy of the approximate adder 20 and the approximate adder 60 are the same.

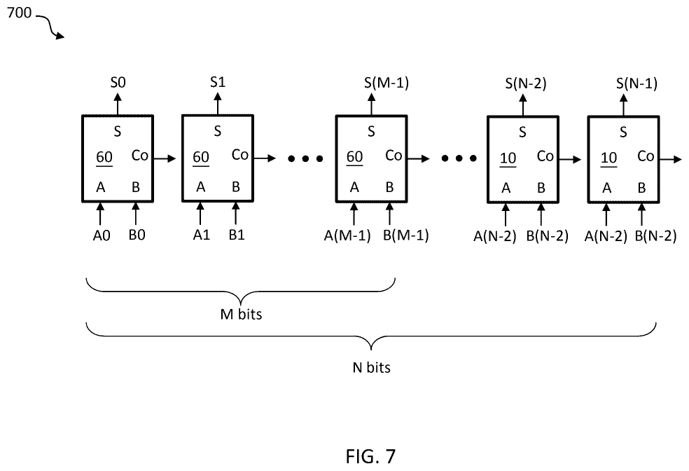

Reference is now made to FIG. 7. FIG. 7 is a schematic diagram illustrating an adder circuit 700, in accordance with various embodiments of the present disclosure. With respect to the embodiments of FIGS. 1 to 6, like elements in FIG. 7 are designated with the same reference numbers for ease of understanding. The specific operations of similar elements, which are already discussed in detail in above paragraphs, are omitted herein for the sake of brevity. In some embodiments, the adder circuit 700 is configured with respect to, for example, the adder circuit 300 of FIG. 3.

Compared with the adder circuit 300 in FIG. 3, instead of having the approximate adder 20 for addition operations on the LSBs of inputs, the N-bit adder circuit 700 includes the number M of approximate adders 60 coupled in series with each other and the number (N-M) of full adders 10 coupled in series with each other. The last one in series of the approximate adder 60 is coupled to the first one in series of the full adders 10. Specifically, the approximate adders 60 are configured to perform addition on the first bits A0 and B0 of the inputs A and B to the M-th bits A(M−1) and B(M−1) of the inputs A and B. The full adders 10 are configured to perform addition on the (M+1)-th bits AM and BM of the inputs A and B to the (N−1)-th bits A(N−2) and B(N−2) of the inputs A and B, as shown in FIG. 7.

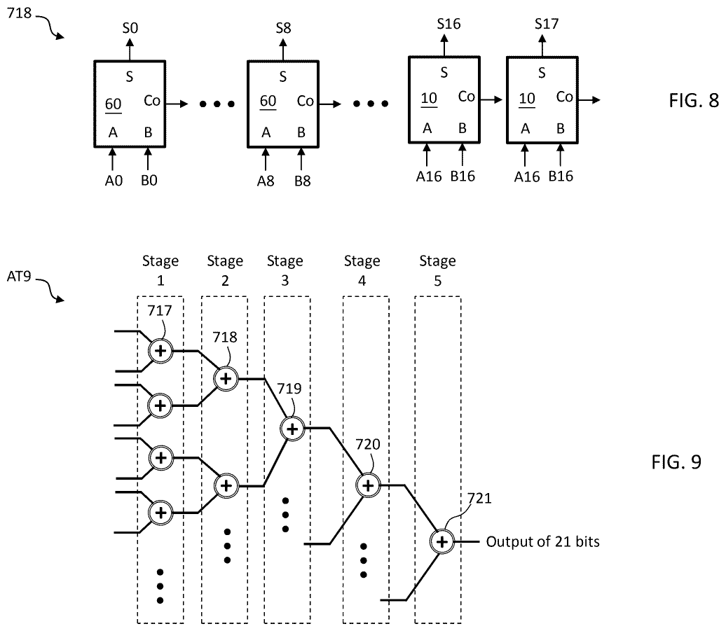

In some embodiments, a ratio of the approximate adders 60 in the adder circuit 700 over the full adders 10 is different from 1. The configurations of FIG. 7 are given for illustrative purposes. Various implements are within the contemplated scope of the present disclosure. For example, in some embodiments, a ratio of the approximate adders 60 in the adder circuit 700 over the full adders 10 equals to 1, as shown in FIG. 8.

Reference is now made to FIG. 8. FIG. 8 is a schematic diagram illustrating an adder circuit 718 corresponding to FIG. 7, in accordance with various embodiments of the present disclosure. The adder circuit 718 is configured as an 18-bit adder having nine approximate adders 60 and nine full adders 10 that are coupled in series to add the 17-bit inputs A and B to output 18-bit sum output S and a 1-bit carry output Co.

Reference is now made to FIG. FIG. 9 is a schematic diagram showing an example of an adder tree AT9, in accordance with various embodiments of the present disclosure.

For illustration, the adder tree AT9 includes at least five stages. In some embodiments, each adder circuit in the adder tree AT9 have similar configurations corresponding to the adder circuit 700 in FIG. 7. For example, an adder circuit 717 is configured with respect to, for example, the adder circuit 700 configured as a 17-bit adder circuit (i.e., M being 8 and N being 17), an adder circuit 718 is configured with respect to, for example, the adder circuit 700 configured as a 18-bit adder circuit (i.e., M being 8 and N being 18), and so on.

As shown in FIG. 9, the adder tree AT9 includes multiple adder circuits 716 in the stage 1 for addition operation of inputs, for example, thirty two 16-bit inputs, and each adder circuit 717 generates a 17-bit sum output and 1-bit carry output to coupled one of the adder circuits 718 in the next stage 2. Each adder circuit 718 generates an 18-bit sum output and 1-bit carry output to coupled one of the adder circuits 719 in the next stage 3, and so on. Accordingly, the adder tree AT9 generates a 21-bit output as result of the sum of thirty two 16-bit inputs.

With the configurations of the present application, interleaved 12-T approximate adder 60 with the 28-T full adders 10 provide high operational speed and less area penalty in adder tree structure.

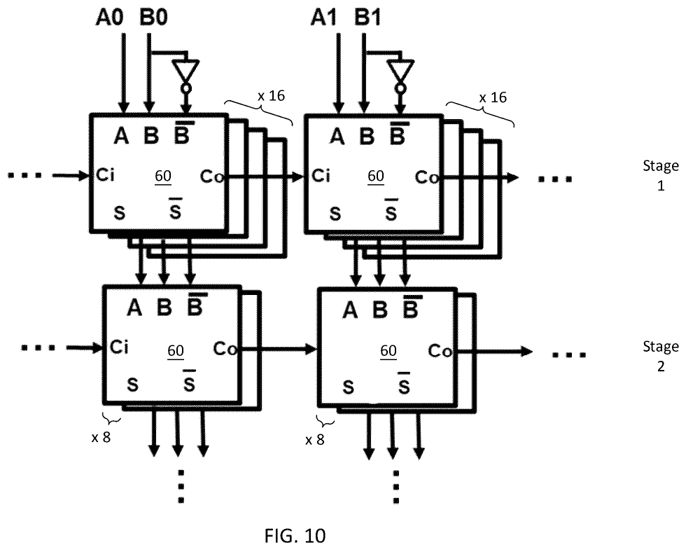

Reference is now made to FIG. 6, FIG. 9, and FIG. 10 that is a schematic diagram showing part of the adder tree corresponding to FIG. 9, in accordance with various embodiments of the present disclosure. According to some embodiments, the adder tree AT9 further includes inverters in the stage 1 to generate inputs B, while the carry outputs Co are further output as sum outputs S to the adders in next stage (e.g., the stage 2).

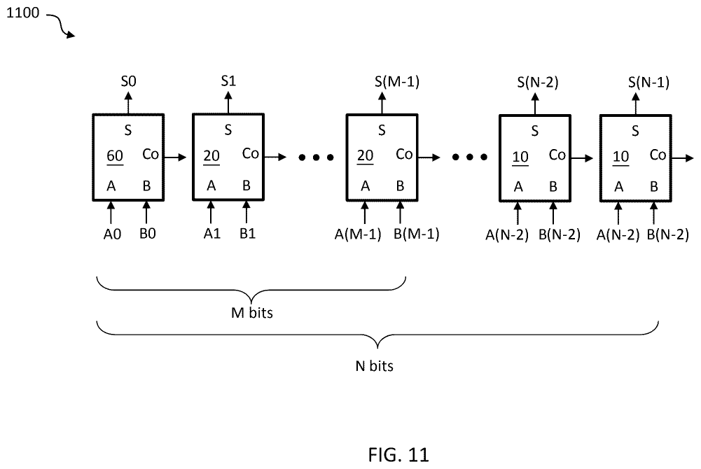

In some embodiments, the adder circuit is composed of more than two different types of adders. For example, with reference to FIG. 11 illustrating an adder circuit 1100 in accordance with various embodiments of the present disclosure, the adder circuit 1100 includes a combination of the full adders 10, the approximate adders 20, and the approximate adder 60.

As shown in FIG. 11, the N-bit adder circuit 1100 includes the number (N−M) of the full adders 10 and further includes the number (M/2) of the approximate adders 60 plus the number (M/2) of the approximate adders 20 that are interleaved and coupled in series with each other for addition on the first bits A0 and B0 of the inputs A and B to the M-th bits A(M−1) and B(M−1) of the inputs A and B. Alternatively stated, one of the approximate adders 60 is interposed between two adjacent approximate adders 2. The full adders 10 are configured to perform addition on MSBs—the (M+1)-th bits AM and BM of the inputs A and B to the (N−1)-th bits A(N−2) and B(N−2)—of the inputs A and B.

In some embodiments, M is smaller than (N/2), for example, N being 18 and M being 4 for a higher accuracy of the adder circuit.

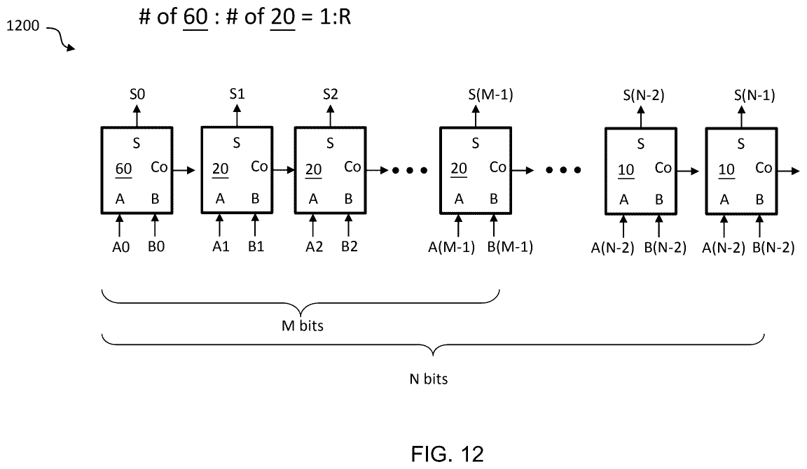

As mentioned above, the embodiments of FIG. 11 have a ratio of the approximate adders 60 to the approximate adders 20 equal to 1, and ratio of the full adders 10 to a sum of the approximate adders 20 and the approximate adder 60 equal to 1. The configurations of FIG. 11 are given for illustrative purposes. Various implements are within the contemplated scope of the present disclosure. For example, in some embodiments of FIG. 12, a ratio of the approximate adders 60 and the approximate adders 20 is different from 1:1.

Reference is now made to FIG. 12. FIG. 12 is a schematic diagram illustrating an adder circuit 1200 corresponding to FIG. 11, in accordance with various embodiments of the present disclosure. As shown in FIG. 12, a ratio of the approximate adders 60 and the approximate adders 60 is 1:R, in which R is 2. In other embodiments, R is a number larger than 1.

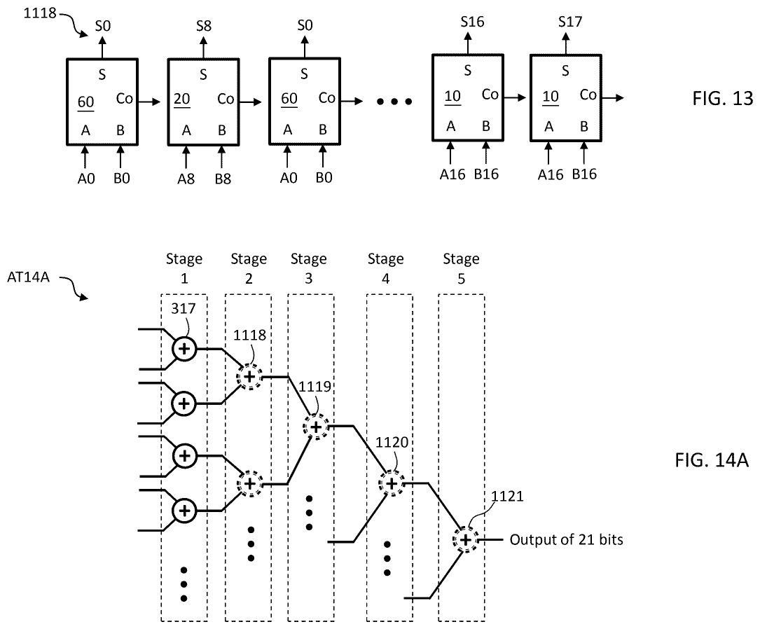

Reference is now made to FIG. 13. FIG. 13 is a schematic diagram illustrating an adder circuit 1118 corresponding to FIG. 11, in accordance with various embodiments of the present disclosure. The adder circuit 1118 is configured as an 18-bit adder including four approximate adders 20, five approximate adders 60 and nine full adders 10 that are coupled in series to add the 17-bit inputs A and B to output 18-bit sum output S and a 1-bit carry output Co. In other embodiments, the adder circuit 1118 including five approximate adders 20, fourth approximate adders 60 and nine full adders 10.

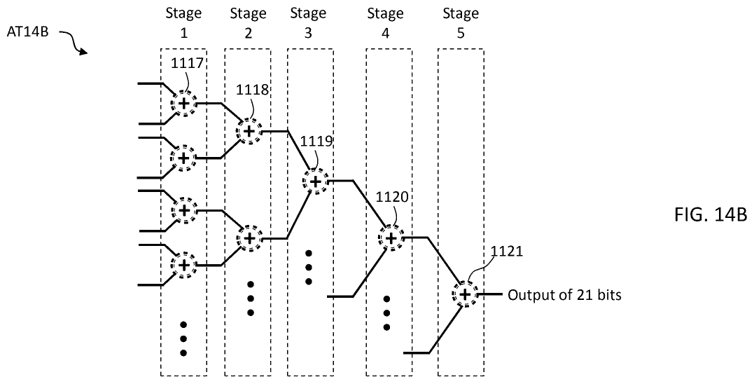

In some embodiments, an adder tree includes a combination of adder circuits of different types, for example, multiple adder circuits configured with respect to, for example, the adder circuit 300 and multiple adder circuits configured with respect to, for example, the adder circuit 1100, as shown in FIG. 14A.

Reference is now made to FIG. 14A. FIG. 14A is a schematic diagram showing an example of an adder tree AT14A, in accordance with various embodiments of the present disclosure.

For illustration, the adder tree AT14 includes at least five stages. In some embodiments, the adder tree AT14 includes the adder circuits 317 in the stage 1 and adder circuits having similar configurations corresponding to the adder circuit 1100 in FIG. 11 for other stages.

The adder circuits 316 in the stage 1 for addition operation of inputs, for example, thirty two 16-bit inputs, and each adder circuit 317 generates a 17-bit output to coupled one of the adder circuits 1118 in the next stage 2, in which the adder circuit 1118 is configured with respect to, for example, the adder circuit 1100 configured as a 18-bit adder circuit (e.g., M being 9 and N being 18). Each adder circuit 118 generates an 18-bit sum output and 1-bit carry output to coupled one of the adder circuits 1119 in the next stage 3 configured with respect to, for example, the adder circuit 1100 configured as an 19-bit adder circuit (e.g., M being 9 and N being 19), and so on. Accordingly, the adder tree AT14A generates a 21-bit output as result of the sum of thirty two 16-bit inputs.

With the configurations of the present application, interleaved approximate adders of different types and full adders provide high operational speed and better area efficacy, for example, at least 10% improvements in delay control and at least 5% in area save.

Reference is now made to FIG. 14B. FIG. 14B is a schematic diagram showing an example of an adder tree AT14B, in accordance with various embodiments of the present disclosure. In some embodiments, the adder tree AT14B is configured with respect to, for example, the adder tree AT14A of FIG. 14B.

Compared with the embodiments of FIG. 14A, instead of having the adder circuits 317 in the stage 1, the adder tree AT14B includes adder circuits 1117 configured with respect to, for example, the adder circuit 1100 configured as a 17-bit adder circuit (e.g., M being 8 and N being 17.)

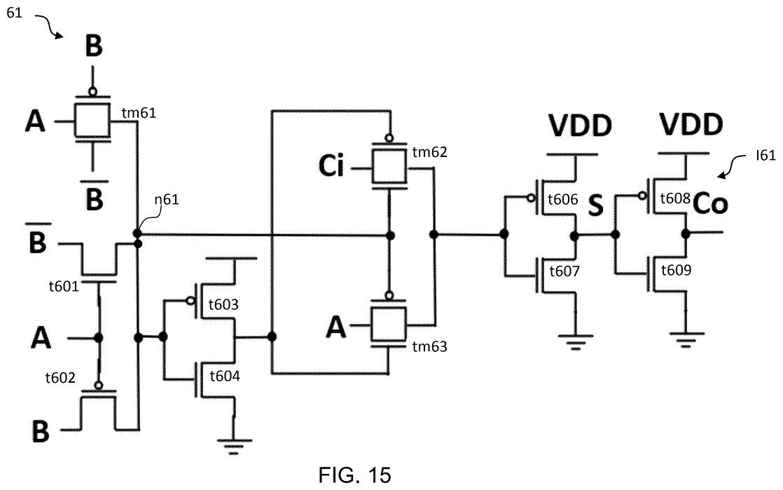

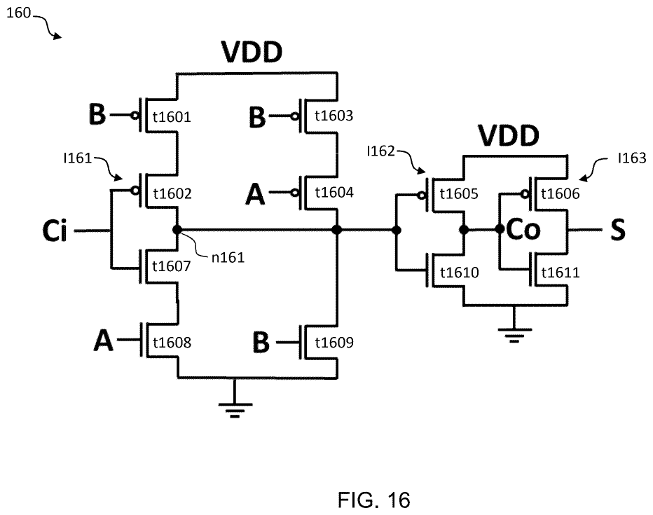

In some embodiments, as shown in FIG. 15, alternative approximate adder 61 is proposed for adder circuit, for example, 700, 1100, or 1200. Compared with the approximate adder 60 of FIG. 6, the approximate adder 61 further includes an inverter 161 composed of a P type transistor t608 and an N type transistor t609. In some embodiments, the inverter 161 is configured to generate the carry output Co by inverting the sum output S generated by the transistors t606-t607. In some embodiments, a number of inverters configured with respect to, for example, the inverter 161 are implemented as a delay chain for desired signal delay in the carry output Co.

Reference is now made to FIG. 16. FIG. 16 is a schematic diagram illustrating an approximate adder 160, in accordance with various embodiments of the present disclosure.

As shown in FIG. 16, the approximate adder 160 includes 11 transistors t1601 to t1611. Specifically, P type transistors t1601-t1602 are coupled in series with N type transistors t1607-1608 between the supply voltage VDD and the ground. P type transistors t1603-t1604 and t1609 are coupled is series between the supply voltage VDD and the ground. In some embodiments, the transistors t1601, t1603, t1609 are configured to operate in response to the input B, and the transistors t1604, t1608 are configured to operate in response to the input A. An inverter 1161 formed by the transistors t1602 and t1607 inverts the carry input Ci and has an output coupled to the transistors t1604, t1609 at a node n161. The transistors t1605 and t1610 form an inverter 1162 having an input coupled to the node n161 and an output for the carry output Co. The transistors t1606 and t1611 form an inverter 1163 having an input coupled to the carry output Co and an output for the sum output S.

In some embodiments, the approximate adder 160 truth table is shown as Table II below. In some embodiments, as shown in table II, an error occurs in the sum output S when the inputs A, B, and the carry input Ci are all “0” or all “1” and errors occur in both of the sum output S and the carry output Co when the input A and the carry input Ci equal to “0” and the input B equals to “1.” Accordingly, accuracy of the approximate adder 160 is worse than accuracy of the approximate adder 20 and the approximate adder 60.

TABLE II
truth table of the approximate adder 160

| | |
|---|---|
| INPUT | OUTPUT |

| A | B | Ci | S | Co |
|---|---|---|---|---|
| 0 | 0 | 0 | 1 (X) | 0 |
| 0 | 0 | 1 | 1 | 0 |
| 0 | 1 | 0 | 0 (X) | 1 (X) |
| 0 | 1 | 1 | 0 | 1 |
| 1 | 0 | 0 | 1 | 0 |
| 1 | 0 | 1 | 0 | 1 |
| 1 | 1 | 0 | 0 | 1 |
| 1 | 1 | 1 | 0 (X) | 1 |

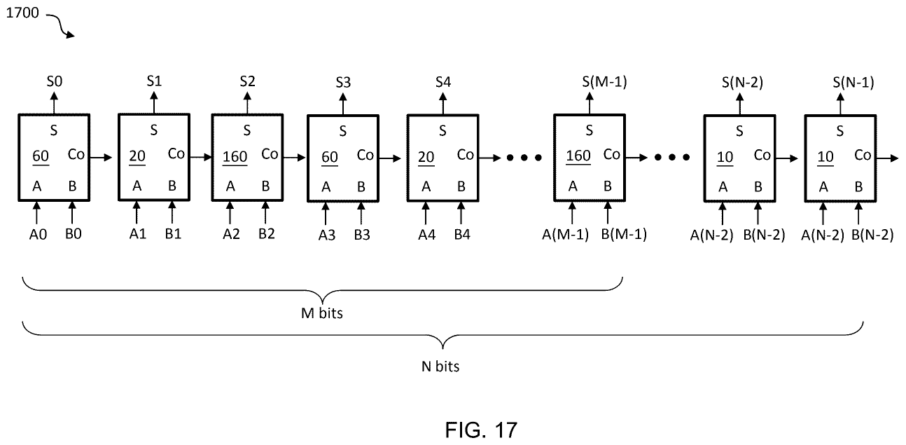

In some embodiments, the adder circuit is composed of four different types of adders. For example, with reference to FIG. 17 illustrating an adder circuit 1700 in accordance with various embodiments of the present disclosure, the adder circuit 1700 includes a combination of the full adders 10, the approximate adders 20, the approximate adder 60, and the approximate adders 160.

As shown in FIG. 17, a ratio of the approximate adders 20, the approximate adder 60, and the approximate adders 160 in the N-bit adder circuit 1700 is 1:1:1. Specifically, in some embodiments, the adder circuit 1700 includes the number (N−M) of the full adders 10 and further includes the number (M/3) of the approximate adders 60 plus the number (M/3) of the approximate adders 20 and the number (M/3) of the approximate adders 160 that are interleaved and coupled in series with each other for addition on the first bits A0 and B0 of the inputs A and B to the M-th bits A(M−1) and B(M−1) of the inputs A and B. The full adders 10 are configured to perform addition on MSBs—the (M+1)-th bits AM and BM of the inputs A and B to the (N−1)-th bits A(N−2) and B(N−2)—of the inputs A and B.

In some embodiments, the adder circuit 1700 is implemented in the aforementioned adder trees in the present application.

The configurations of FIG. 17 are given for illustrative purposes. Various implements are within the contemplated scope of the present disclosure. For example, in some embodiments, a ratio of the approximate adders 20, the approximate adder 60, and the approximate adders 160 is N_{T14}:N_{T12}:N_{T11}, in which N_{T14}, N_{T12}, N_{T11} are different from each other.

The configurations of FIG. 1 to FIG. 17 are given for illustrative purposes. Various implements are within the contemplated scope of the present disclosure. In some embodiments, the full adder 10 can be implemented by any other suitable full adder having high accuracy, for example, a typical fourteen-transistor full adder.

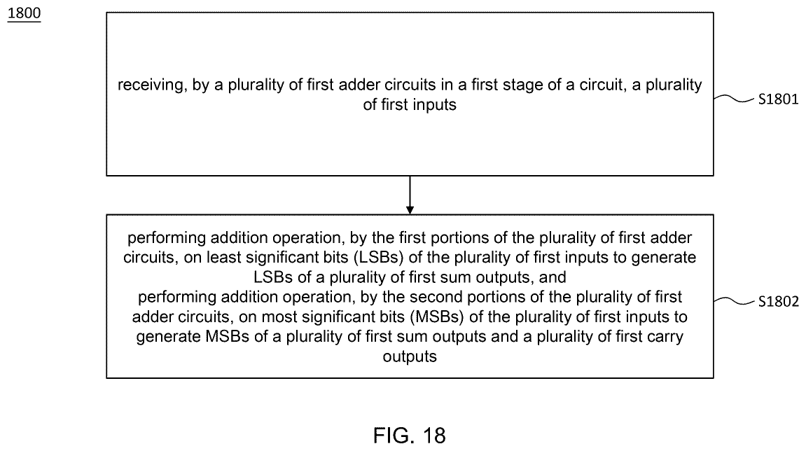

Reference is now made to FIG. 18. FIG. 18 is a flowchart diagram of a method 1800 for operating a circuit including adder circuits configured with respect to, for example, the adder circuit 300, 700, 1100, 1200, or 1700, in accordance with some embodiments of the present disclosure. It is understood that additional operations can be provided before, during, and after the processes shown by FIG. 18, and some of the operations described below can be replaced or eliminated, for additional embodiments of the method. The order of the operations/processes may be interchangeable. Throughout the various views and illustrative embodiments, like reference numbers are used to designate like elements. The method 1800 includes operations S1801-S1802 that are described below with reference to the embodiments in FIG. 1 to FIG. 17.

In operation S1801, for example, as shown in FIG. 14A, the adder circuits 316 in the stage 1 receive thirty two inputs.

In operation S1802, the adders, for example, approximate adders 20 in the adder circuits 317 perform addition operation on LSBs, for example, first bits to the (M−1)-th bits of inputs to generate LSBs of sum outputs and corresponding carry outputs Co. The adders, for example, the full adders 10 in the adder circuits 317 perform addition operation on MSBs, for example, M-th bits to the (N−1)-th bits of inputs and the corresponding carry outputs Co to generate MSBs of sum outputs and carry outputs Co.

In some embodiments, the method 1800 further includes operation of performing addition operation, by the approximate adders 20 and the approximate adders 60 in the adder circuits 1118 in the stage 2, on the LSBs of the sum outputs from the stage 1 to generate LSBs of sum outputs and corresponding carry outputs Co, and the method 1800 further includes operation of performing addition operation, by the full adders 10 in the adder circuits 1118, on the MSBs of the sum outputs from the stage 1 and the corresponding carry outputs Co to generate MSBs of the sum outputs and the carry outputs Co.

As described above, circuit and operating method of adder circuits are provided. In some embodiments, a 12-transistor approximate adder offers reduced area and delay. By utilizing interleaved approximate adders for addition operation on the least significant bits in the adder tree improves power, performance, and area (PPA) without sacrificing accuracy.

In some embodiments, a circuit is provided. The circuit includes a first adder circuit configured to output N bits, comprising: a first bit adder to an M-th bit adder, wherein a first portion of the first bit adder to the M-th bit adder comprises a plurality of first adders each having a first number of transistors; and an (M+1)-th bit adder to an N-th bit adder comprising a plurality of second adders each having a second number of transistors, wherein first accuracy of one in the first adders is worse than second accuracy of one in the second adders, M and N being natural numbers.

In some embodiments, a circuit is provided. The circuit comprises an adder circuit, comprising: a plurality of first adders that are coupled in series and each one has a first number of transistors; and a plurality of second adders that are coupled in series and each one has a second number of transistors, wherein a last one in the plurality of first adders is coupled to a first one in the plurality of second adders, the first number being smaller than the second number.

In some embodiments, a method is provided. The method comprises: receiving, by a plurality of first adder circuits in a first stage of a circuit, a plurality of first inputs, wherein each in the plurality of first adder circuits comprises: a first portion comprising a first number of a plurality of first adders, a second number of a plurality of second adders, a third number of a plurality of third adders, or a combination; and a second portion comprising a fourth number of a plurality of fourth adders; and performing addition operation, by the first portions of the plurality of first adder circuits, on least significant bits (LSBs) of the plurality of first inputs to generate LSBs of a plurality of first sum outputs, and performing addition operation, by the second portions of the plurality of first adder circuits, on most significant bits (MSBs) of the plurality of first inputs to generate MSBs of a plurality of first sum outputs.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A circuit, comprising:
a first adder circuit configured to output N bits, comprising:
a first bit adder to an M-th bit adder, wherein a first portion of the first bit adder to the M-th bit adder comprises a plurality of first adders each having a first number of transistors; and
an (M+1)-th bit adder to an N-th bit adder comprising a plurality of second adders each having a second number of transistors, wherein first accuracy of one in the first adders is lower than second accuracy of one in the second adders, M and N being natural numbers.

2. The circuit of claim 1, wherein the second number is greater than the first number.

3. The circuit of claim 1, wherein a second portion of the first bit adder to the M-th bit adder further comprises a plurality of third adders each having a third number of transistors, wherein the third number is smaller than the first number.

4. The circuit of claim 3, wherein a ratio of the plurality of first adders to the plurality of third adders is different from 1:1.

5. The circuit of claim 3, wherein the plurality of first adders and the plurality of third adders are interleaved.

6. The circuit of claim 4, wherein a ratio of the plurality of first adders to the plurality of second adders is different from 1.

7. The circuit of claim 3, wherein a third portion of the first bit adder to the M-th bit adder further comprising a plurality of fourth adders each having a fourth number of transistors, wherein the fourth number is different from the third number.

8. The circuit of claim 3, wherein each of the third adders comprises:
a first transmission gate coupled between a first input and a first node and further coupled to a second input and an inverted second input;
a first transistor coupled between the inverted second input and the first node;
a second transistor coupled between the second input and the first node, wherein control terminals of the first and second transistors are coupled to the first input;
a first inverter having an input terminal coupled to the first node;
a second transmission gate coupled between a third input and a first output terminal of the third adder and further coupled to an output terminal of the first inverter and the first node;
a third transmission gate coupled between the first input and the first output terminal of the third adder and further coupled to the output terminal of the first inverter and the first node; and
a second inverter coupled between the first output terminal of the third adder and a second output terminal of the third adder.

9. The circuit of claim 1, further comprising:
a second adder circuit configured to output (N+1) bits that is coupled to the first adder circuit and comprises:
a first bit adder to an (M+1)-th bit adder that comprise other first adders and a plurality of third adders, wherein each of the plurality of third adders has a third number of transistors, the third number being smaller than the first number; and
an (M+2)-th bit adder to an (N+1)-th bit adder comprising other second adders.

10. A circuit, comprising:
an adder circuit, comprising:
a plurality of first adders that are coupled in series and each one has a first number of transistors; and
a plurality of second adders that are coupled in series and each one has a second number of transistors, wherein a last one in the plurality of first adders is coupled to a first one in the plurality of second adders, the first number being smaller than the second number.

11. The circuit of claim 10, wherein the adder circuit further comprises:
a plurality of third adders each interposed between two in the plurality of first adders, each of the third adders comprising:
a first transmission gate coupled between a first input and a first node and further coupled to a second input and an inverted second input;
a first transistor coupled between the inverted second input and the first node;
a second transistor coupled between the second input and the first node, wherein control terminals of the first and second transistors are coupled to the first input;
a first inverter having an input terminal coupled to the first node;
a second transmission gate coupled between a third input and a first output terminal of the third adder and further coupled to an output terminal of the first inverter and the first node;
a third transmission gate coupled between the first input and the first output terminal of the third adder and further coupled to the output terminal of the first inverter and the first node; and
a second inverter coupled between the first output terminal of the third adder and a second output terminal of the third adder.

12. The circuit of claim 11, wherein the first transmission gate comprises:
a P type transistor having a control terminal coupled to the second input; and
an N type transistor having a control terminal coupled to the inverted second input, wherein the P type transistor and the N type transistor are coupled in parallel between the first input and the first node.

13. The circuit of claim 12, wherein the first transistor is an N type transistor, and the second transistor is a P type transistor.

14. The circuit of claim 11, wherein the third input corresponds to a carry input of a current adder in the plurality of third adders and a carry output from a previous adder in the plurality of third adders, and
an output from the second output terminal of the third adder corresponds to a sum output.

15. The circuit of claim 11, wherein a control terminal of a P type transistor in the second transmission gate and a control terminal of an N type transistor in the third transmission gate are coupled to the output terminal of the first inverter.

16. The circuit of claim 15, wherein a control terminal of an N type transistor in the second transmission gate and a control terminal of a P type transistor in the third transmission gate are coupled to the first node.

17. The circuit of claim 11, wherein one of the third adders further comprises:
a third inverter coupled to the second output terminal of the third adder and configured to generate a carry output based on the first input and the second input.

18. A method, comprising:
receiving, by a plurality of first adder circuits in a first stage of a circuit, a plurality of first inputs, wherein each in the plurality of first adder circuits comprises:
a first portion comprising a first number of a plurality of first adders, a second number of a plurality of second adders, a third number of a plurality of third adders, or a combination; and
a second portion comprising a fourth number of a plurality of fourth adders; and
performing addition operation, by the first portions of the plurality of first adder circuits, on least significant bits (LSBs) of the plurality of first inputs to generate LSBs of a plurality of first sum outputs, and performing addition operation, by the second portions of the plurality of first adder circuits, on most significant bits (MSBs) of the plurality of first inputs to generate MSBs of a plurality of first sum outputs.

19. The method of claim 18, wherein at least two in the first number, the second number, the third number, and the fourth number are different from each other.

20. The method of claim 18, further comprising:
performing addition operation, by first portions of a plurality of second adder circuits in a second stage, on the LSBs of the plurality of first sum outputs to generate LSBs of a plurality of second sum outputs, and performing addition operation, by second portions of the plurality of second adder circuits, on the MSBs of the plurality of first sum outputs to generate MSBs of a plurality of second sum outputs,
wherein corresponding two in the plurality of first adder circuits are coupled to one in the plurality of second adder circuits,
wherein at least one adder in the first portion of one in the plurality of second adder circuits in the second stage has fewer transistors than any of adders in the first portions of the plurality of first adder circuits in the first stage.
